(19) United States
(12) Patent Application Publication
(10) Pub. No.: US 2005/0283811 A1
(43) Pub. Date: Dec. 22, 2005

(54) Process for distributing video sequences, decoder and system for carrying out this process

(75) Inventor: Daniel LeComte, Paris (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: MEDIALIVE, a corporation of France, Paris (FR)

(21) Appl. No.: 11/181,077

(22) Filed: Jul. 14, 2005

Related U.S. Application Data
(63) Continuation of application No. PCT/FR04/50017, filed on Jan. 15, 2004.

(30) Foreign Application Priority Data
Jan. 15, 2003 (FR) FR 03/00406

(51) Int. Cl. H04N 7/173; H04N 7/16

(52) U.S. Cl. 725/95; 725/135; 725/118

(57) ABSTRACT

A process for distributing video sequences including broadcasting a main digital stream and complementary information necessary for displaying a video sequence, and reconstructing the displayable video stream at a reception site on apparatus having a screen, wherein the recaption site includes a personal computer with mass storage and a peripheral for video processing provided with a communicator for the personal computer and transmitting the displayable video stream to a display device, wherein the main digital stream is received by the personal computer and a software application for reconstructing the display stream is executed in the video processing peripheral and not in the personal computer.

### RELATED APPLICATION

This is a continuation of International Application No. PCT/FR2004/050017, with an international filing date of Jan. 15, 2004 (WO 2004/066627, published Aug. 5, 2004), which is based on French Patent Application No. 03/00406, filed Jan. 15, 2003.

### FIELD OF THE INVENTION

This invention relates to the secured distribution of video sequences.

### BACKGROUND

A technique for securing a video sequence consists of altering the digital video stream at the moment of broadcasting so that it is compatible with standard formats and can be recognized by reading equipment, but can not be displayed in a satisfactory state by a recipient. Complementary information is transmitted via a separate path. The combination of the main digital stream and complementary information alone permits the displaying of the initial video sequence.

The user has a decoder that receives this main digital stream, also called the “modified” video stream, as well as the complementary information. This decoder must have a means of mass storage to ensure a buffer between the entering stream, that can be limited by the throughput of the connection between the decoder and the network, and the video processor ensuring reconstruction. Thus, relatively expensive equipment is concerned. That limits the possibilities of broadcasting sequences in accordance with that technique.

It would therefore be advantageous to provide for the implementation of a simplified decoder while guaranteeing a high degree of security against pirating.

### SUMMARY OF THE INVENTION

This invention relates to a process for distributing video sequences including broadcasting a main digital stream and complementary information necessary for displaying a video sequence, and reconstructing the displayable video stream at a reception site on apparatus having a screen, wherein the reception site comprises a personal computer with mass storage and a peripheral for video processing provided with a communicator for the personal computer and transmitting the displayable video stream to a display device, wherein the main digital stream is received by the personal computer and a software application for reconstructing the display stream is executed in the video processing peripheral and not in the personal computer.

This invention also relates to a decoder including an input that receives a digital stream coming from a personal computer, a video processing circuit that reconstructs a displayable stream from a main digital stream and complementary information, and an output delivering a video signal that can be displayed on a display device.

This invention further relates to a system including the decoder and a personal computer including a reader for disks on which main digital streams are recorded and the decoder includes means for communicating with the personal computer for receiving the main digital stream.

### BRIEF DESCRIPTION OF THE DRAWINGS

The invention will be better understood from a reading of the following description that refers to the attached drawings corresponding to non-limiting exemplary embodiments in which:

FIG. 1 shows a schematic diagram of a decoder in accordance with aspects of the invention;

FIG. 2 shows a variant of a decoder in accordance with aspects of the invention; and

FIG. 3 shows another variant of a decoder in accordance with aspects of the invention.

### DETAILED DESCRIPTION

This invention concerns, in a broad sense, a process for distributing video sequences comprising broadcasting a main digital stream and complementary information necessary for displaying the video sequence, and reconstructing the displayable video stream at the reception site on equipment provided with a screen, wherein the reception site comprises a personal computer comprising a high-speed connection and mass storage means and a peripheral for video processing provided with means for communicating with the personal computer and for transmitting the displayable stream to a display device, which main digital stream is received by the personal computer and the software application for reconstructing the display stream is executed in the video processing peripheral and not in the personal computer.

Moreover, the main digital stream is transmitted by the server via a digital network and the personal computer comprises a high-speed connection for receiving this main digital stream.

The main digital stream is advantageously transmitted by the server via a material support and personal computer comprises a reader for exploiting this material support and reading this main digital stream.

According to a first aspect, the complementary information may be received by the personal computer and the main digital stream and the complementary information may be transmitted by the main computer to the video processing peripheral.

According to another aspect, the complementary information may be received by the video processing peripheral and the main digital stream may be transmitted by the main computer to the video processing peripheral.

According to yet another aspect, the complementary information and the main digital stream may be received by the video processing peripheral and the main digital stream may be transmitted by the video processing peripheral to the main computer to be recorded in its mass storage to be replayed subsequently.

Furthermore, the main digital stream conforms to the norm or standard of the original video stream.

In one aspect, the personal computer comprises a routing module for the complementary information between the server and the video processing peripheral of the decoder.

In another aspect, an authentication may be performed between the video server and the video processing peripheral of the decoder during the request for complementary information and the information relative to this authentication flows via a path separate from the personal computer.

In yet another aspect, an authentication may be performed between the video server and the video processing peripheral of the decoder during the request for complementary information and the information relative to this authentication flows via the personal computer.

The invention also concerns a decoder comprising an input for receiving a digital stream coming from a personal computer, a video processing circuit for reconstructing a displayable stream from the digital stream and from complementary information, and comprises an output delivering a video signal that can be displayed on a display device.

The decoder preferably has no hard disk and in particular has no means for storing a digital stream and a video stream. The decoder advantageously comprises means for communicating with a network for the reception of the complementary information. It may also comprise means for communicating with a personal computer for the reception of the complementary information. The decoder advantageously comprises a smart card reader.

The complementary information is advantageously recorded in the memory of the smart card. According to a preferred aspect, it comprises means for wireless communication with a personal computer for reception of the digital stream.

The invention also includes a system for implementing the process comprising a decoder, a personal computer, which personal computer comprises a reader for disks on which the main digital streams are recorded and which decoder comprises means for communicating with the personal computer for receiving the main digital stream.

Each user should have two pieces of complementary equipment for reception and exploitation of the broadcasted video sequences:
a non-modified personal computer 1, and
a decoder 2.

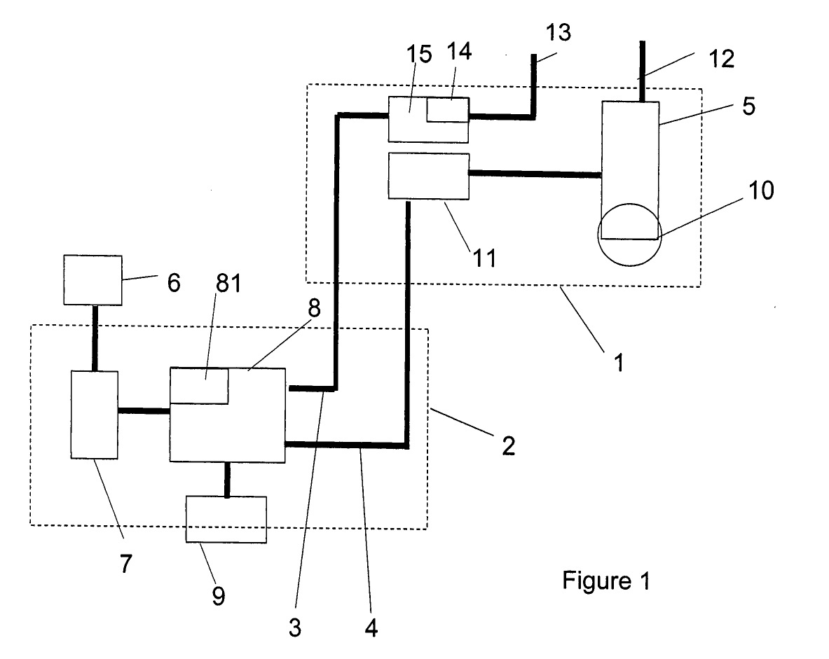

In FIG. 1, decoder 2 comprises an output for connecting at least one display device, e.g., a monitor, a video projector or a device such as a TV screen 6.

Decoder 2 primarily comprises on the one hand a processing unit adapted for processing, in particular, decoding and descrambling any digital video stream, e.g., of the MPEG type in accordance with a preloaded decoding and descrambling software program in such a manner as to display it in real time, and comprises on the other hand at least one screen interface 7.

The decoder is also connected to a computer 1 by one or more wire connections, e.g., of the Ethernet, Firewire or USB-2 type or by one of the wireless connections, e.g., of the Bluetooth, WiFi or AirPort type. Connection 3 routes the complementary information and connection 4 routes the modified video stream via the server to render it unusable in its state.

Connection 3 is advantageously merged with connection 4.

When the user of decoder 2 wishes to actually display the audiovisual program on screen 6, the user requests this from synthesis system 8 with a remote control as with a video cassette recorder or a DVD reader, having a menu on his TV screen 6. The decoder communicates with computer 1 for releasing the transmission of the modified video stream. Synthesis system 8 begins to analyze the modified digital stream coming from hard disk 10 of the computer via reading buffer 11 of the computer. Computer 1 then establishes a connection with the video server via telecommunication network 12, which is a DSL connection in the example.

Hard disk 10 of computer 1 can be used as a buffer memory to temporarily store at least part of the program or the video sequence to be displayed in the case of off-line displaying or a limitation in the bandwidth of transmission network 12. The display can be delayed or differed upon the request of the user or of the video server.

As FIG. 1 shows, connection interface 5 of computer 1 is connected to transmission and broadband broadcasting network 12 such as a modem, satellite modem, cable modem fiber optic line interface or radio or infrared interface for wireless communication.

The content of audiovisual programs such as films are transmitted via this classic video broadcasting connection. However, to not allow pirated copies to be made, provision is made prior to transmitting the audiovisual content from the server to retain a small part of the audiovisual content in the portal or the video server.

When displaying an audiovisual program in real time, this small part of the audiovisual content, also called “complementary information,” retained in the server may also be transmitted to interface module 15 via telecommunication network 13 that can be the same network as that for transmission and broadband broadcasting 12.

Module 15 advantageously comprises a routing function 14 permitting the transfer of data between the video server and decoder 2 in such a manner that no specific processing of the data is carried out by computer 1.

As the successive images/pictures of a video sequence comprise a large number of identical visual elements (as in a movie, one image resembles the preceding one), MGEG only records the elements that differ from the original image. For example, and in a non-limiting manner, an entire reference image is modified while retaining the DC coefficients of the modifications added in the portal, and it is not necessary to add modifications for the successive images that depend on the reference image I since they will cause the displayed stream to diverge on account of disturbances added to reference images I. The MPEG compression thus begins in a first time by decomposing the image into different square matrices each comprising several points or pixels, each of which has its own calorimetric value. A calculation permits the obtention of an average value for each matrix in which each point is now anchored. This processing generates a pixellation and the appearance of uniform solid colors/flat tints where nuances of color/tint existed. The second stage of the MPEG compression comprises retaining only the changing elements from one image to the other.

In the case of an audiovisual program of the MPEG type, all the characteristics of the I images coming from the video server are not transmitted to module 5. In particular, the characteristics can be the CD correlation coefficients contained in images I.

Certain DC coefficients of these images I are retained in the video server. On the other hand, in lieu of the DC coefficients of these non-transmitted images I, the server intercalates false DC coefficients of the same nature as the DC coefficients removed and retained in the portal in such a manner that that the standard MPEG reader of module 8 is not disturbed by these modifications, that it ignores, and reconstitutes at the output an MPEG output stream that is incorrect from the visual standpoint of a human being, but correct from the viewpoint of MPEG format, that is to say that the main digital stream containing the false DC coefficients is in conformity with the MPEG norm. In a general manner, the modifications to the coefficients are carried out in such a manner that the modified main digital stream strictly conforms to the norm or standard of the original digital video stream.

MPEG reader 8 of decoder 2 is a standard MPEG reader and is not modified or affected in any manner by the changes made to images I.

As FIG. 1 shows, the connection interface of computer 1 is connected to a wide area telecommunication network either directly or via a local network functioning as an access network and is constituted, e.g., by a subscriber interface line (analog or digital telephone network, DSL, BLR (radio local loop), GSM, GPRS, UMTS and the like).

Thus, the audiovisual programs are broadcasted in a classic manner in a multibroadcast mode via broadband transmission network 12 of the microwave, cable, satellite, digital radio, DSL or the like. Each audiovisual program broadcast in this manner can be encrypted or non-encrypted and the streams of the MPEG type comprise modifications at the level of certain I images as described above. Certain audiovisual programs modified in this manner and incomeplete are recorded on the hard disk of computer 1 as a function of the parameters selected by the user or of information transmitted by the broadcasting server.

When the user wishes to display an audiovisual program recorded in this manner on hard disk 10 of his computer 1, the user then connects to the portal via the connection of the local network or direct access type and through the telecommunication network connected itself to the video server.

The connections remain established during the entire display of the audiovisual program and permit computer 1 to receive via connection 13 the functions and parameters for putting the modified DC coefficients of images I back in order. The main digital stream from the hard disk of computer 1 and the complementary information from the video server via connection 13 are transmitted by computer 1 to decoder 2 via connections 4 and 3. The combination of the main digital stream and of the complementary information allow only the display of the initial video sequence. The modified DC coefficients of images I transmitted are never recorded on the hard disk of computer 1 because the reconstituted images I are directly displayed on display screen 6 via processing performed by decoder 2 after having been processed by reader 8 from its volatile local memory 81. Once processed and displayed, the modified and/or lacking DC coefficients of images I that were just transmitted by the video server can be deleted from local volatile memory 81 of decoder 2.

Every time that the user wishes to view a program recorded on hard disk 10 of computer 1, the user automatically connects to the server. According to a particular embodiment, computer 1 or decoder 2 comprises smart card reader 9 that allows the portal to authenticate the user that owns decoder 2. Authentication is performed between the video server and the video processing peripheral of the decoder during the request for complementary information. During this authentication stage, the information relative to this authentication passes via the personal computer.

According to a particular embodiment, the smart card contains the complementary information for a given audiovisual MPEG content.

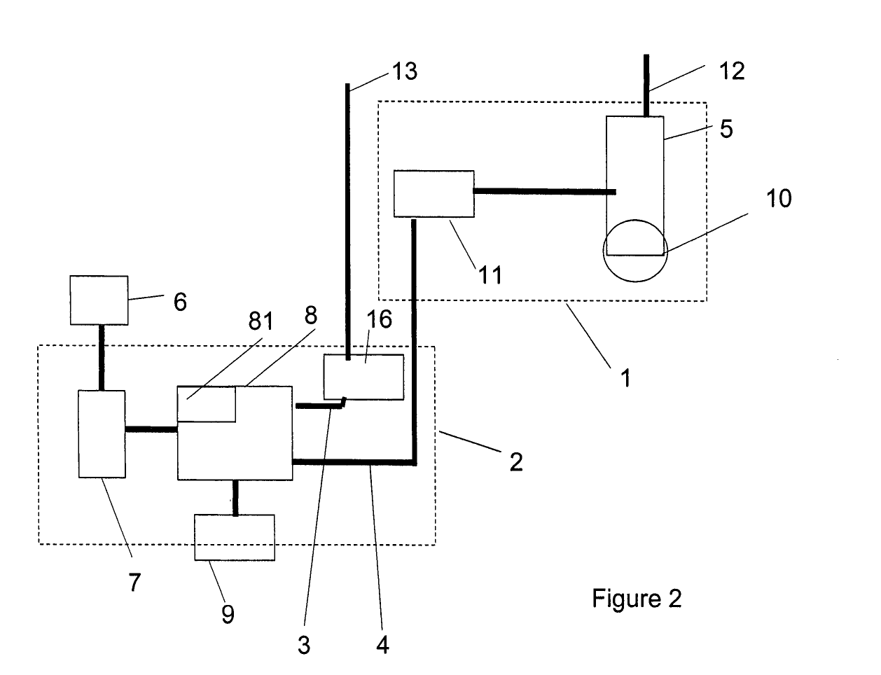

FIG. 2 shows another aspect of an embodiment in which the decoder comprises an interface module of the modem 16 type connected to network 13 to directly receive the complementary information. The modified video stream is received as in the previous example from a computer 1 via connection 4.

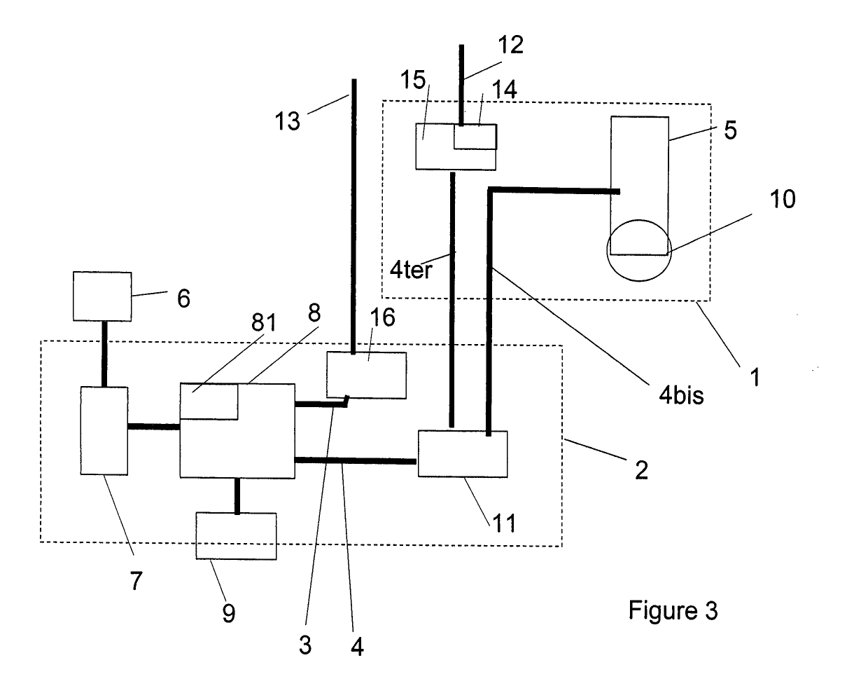

FIG. 3 shows yet another aspect of an embodiment in which the decoder also comprises an interface module 11 connected to network 12 to directly receive the modified main digital stream via interface module 15 and connection 4ter. The modified main digital stream is then also transmitted to computer 1 via connection 4bis to be recorded on hard disk 10. Connection 4bis and connection 4ter are advantageously melded.

In the case of FIGS. 2 and 3, authentication is carried out between the video server and the video processing peripheral of the decoder during the request for complementary information. During the authentication stage, the information relative to the authentication passes via a path separate from the personal computer.

Modems 16 and 11 are advantageously melded as well as the connections to networks 12 and 13.

In FIGS. 1, 2 and 3, computer 1 advantageously comprises a disk reader, e.g., a CD, DVD reader or the like, to directly read main digital streams recorded on disks. The main digital streams are recorded in advance on these disks.

Although this invention has been described in connection with specific forms thereof, it will be appreciated that a wide variety of equivalents may be substituted for the specified elements described herein without departing from the spirit and scope of this invention as described in the appended claims.

1. A process for distributing video sequences comprising: broadcasting a main digital stream and complementary information necessary for displaying a video sequence, and reconstructing the displayable video stream at a reception site on apparatus having a screen, wherein the reception site comprises a personal computer with mass storage and a peripheral for video processing provided with a communicator for the personal computer and transmitting the displayable video stream to a display device, wherein the main digital stream is received by the personal computer and a software application for reconstructing the display stream is executed in the video processing peripheral and not in the personal computer.

2. The process according to claim 1, wherein the main digital stream is transmitted by a server via a digital network and the personal computer comprises a high-speed connection for receiving the main digital stream.

3. The process according to claim 1, wherein the main digital stream is transmitted by a server via a material support and the personal computer comprises a reader for exploiting the digital support and reading the main digital stream.

4. The process according to claim 1, wherein the complementary information is received by the personal computer and the main digital stream and the complementary information are transmitted by the personal computer to the video processing peripheral.

5. The process according to claim 1, wherein the complementary information is received by the video processing peripheral and the main digital stream is transmitted by the personal computer to the video processing peripheral.

6. The process according to claim 5, wherein the main digital stream is received by the video processing peripheral and that the main digital stream is transmitted by the video processing peripheral to the computer to be recorded in its mass storage to be replayed subsequently.

7. The process according to claim 1, wherein the main digital stream conforms to a norm or standard of the original video stream.

8. The process according to claim 1, wherein the personal computer comprises a routing module for the complementary information between a server and the video processing peripheral of the decoder.

9. The process according to claim 1, wherein an authentication is performed between a video server and the video processing peripheral of the decoder during a request for complementary information and the information relative to authentication flows via a path separate from the personal computer.

10. The process according to claim 1, wherein an authentication is performed between a video server and the video processing peripheral of the decoder during a request for complementary information and the information relative to the authentication flows via the personal computer.

11. A decoder comprising an input that receives a digital stream sent from a personal computer, a video processing circuit that reconstructs a displayable stream from a main digital stream and complementary information, and an output delivering a video signal that can be displayed on a display device.

12. The decoder according to claim 11, having no mass storage device.

13. The decoder according to claim 11, further comprising a communication device that communicates with a network for reception of the complementary information.

14. The decoder according to claim 11, further comprising a communication device for communicating with the personal computer for reception of the complementary information.

15. The decoder according to claim 11, further comprising a card reader containing the complementary information.

16. The decoder according to claim 11, further comprising a device for wireless communication with the personal computer.

17. A system comprising a decoder according to claim 11 and a personal computer comprising a reader for disks on which main digital streams are recorded and the decoder comprises means for communicating with the personal computer for receiving the main digital stream.
